(19) United States
(12) Patent Application Publication
(10) Pub. No.: US 2018/0182531 A1
(43) Pub. Date: Jun. 28, 2018

(54) SURFACE-MOUNT INDUCTOR

(71) Applicant: Murata Manufacturing Co., Ltd., Kyoto (JP)

(72) Inventors: Keita MUNEUCHI, Nagaokakyo-shi (JP); Eiji ISO, Nagaokakyo-shi (JP); Hideaki OOI, Nagaokakyo-shi (JP)

(73) Assignee: Murata Manufacturing Co., Ltd., Kyoto (JP)

(21) Appl. No.: 15/842,997

(22) Filed: Dec. 15, 2017

(30) Foreign Application Priority Data
Dec. 22, 2016 (JP) 2016-249652

(51) Int. Cl. H01F 27/255; H01F 27/28; H01F 27/29

(52) U.S. Cl. CPC H01F 27/255; H01F 27/292; H01F 27/2823

(57) ABSTRACT

A surface-mount inductor includes a coil formed by winding a conductor, a molded body made of a sealing material containing a metal magnetic material and a resin with the coil enclosed therein, and an external terminal connected to the coil. The molded body has, in a surface perpendicular to a coil axis of the coil, a first region having a filling factor of the metal magnetic material lower than an average filling factor of the metal magnetic material in the whole of the molded body. The external terminal is disposed on a region at least including the first region.

### CROSS-REFERENCE TO RELATED APPLICATIONS

This application claims priority to Japanese Patent Application No. 2016-249652, filed on Dec. 22, 2016, the disclosure of which is hereby incorporated by reference in its entirety.

### TECHNICAL FIELD

The present disclosure relates to a surface-mount inductor.

### BACKGROUND

In a conventional surface-mount inductor, a coil is formed by winding a conductive wire, and the coil is buried in a molded body formed of a sealing material containing a resin and a magnetic powder such that a lead-out end part of the coil is connected to an external terminal formed on a surface of the molded body (see, e.g., Japanese Laid-Open Patent Publication No. 2005-116708). In this surface-mount inductor, a molded body having a coil incorporated therein is formed by a compression molding method or a powder compacting method, and an external terminal is formed by applying a conductive paste to this molded body.

### SUMMARY

As a first aspect, the present disclosure provides a surface-mount inductor that includes a coil formed by winding a conductor, a molded body made of a sealing material containing a metal magnetic material and a resin with the coil enclosed therein, and an external terminal connected to the coil. The molded body has, in a surface perpendicular to a coil axis of the coil, a first region having a filling factor of the metal magnetic material lower than an average filling factor of the metal magnetic material in the whole of the molded body. The external terminal is disposed on a region at least including the first region.

A second aspect of the present disclosure provides a surface-mount inductor that includes a coil formed by winding a conductor, a molded body made of a sealing material containing a metal magnetic material and a resin with the coil enclosed therein, and an external terminal connected to the coil. The molded body has, in a surface perpendicular to a coil axis of the coil, a third region having a center particle diameter D50 of the metal magnetic material smaller than a center particle diameter D50 of the metal magnetic material in the whole of the molded body. The external terminal is disposed on a region at least including the third region.

### BRIEF DESCRIPTION OF THE DRAWINGS

FIG. 1 is a partial cross-sectional view of a first example of a surface-mount inductor.

FIG. 2 is a schematic cross-sectional view of a structure near a surface of a molded body in the surface-mount inductor.

FIG. 3 is a perspective view for explaining manufacturing steps of the surface-mount inductor.

FIG. 4 is a schematic cross-sectional view of a structure near a surface of a molded body in a second example of the surface-mount inductor.

FIG. 5 is a partial cross-sectional view of a third example of the surface-mount inductor.

FIG. 6 is a schematic cross-sectional view of a structure near a surface of a molded body in a conventional surface-mount inductor.

### DETAILED DESCRIPTION

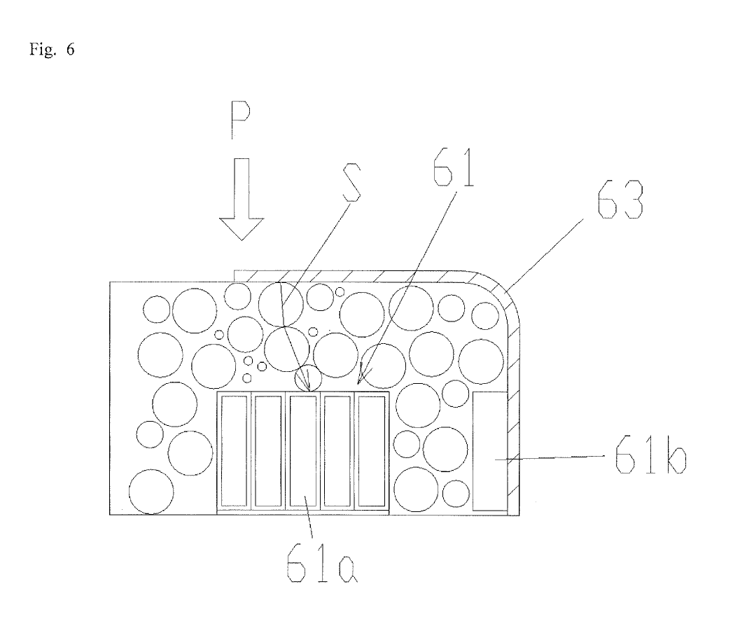

In the conventional surface-mount inductor as described in Japanese Laid-Open Patent Publication No. 2005-116708, the permeability of the molded body is made higher by increasing the density of the magnetic powder of the molded body so as to improve the performance. If a metal magnetic powder is used as the magnetic powder to increase the magnetic permeability of the molded body, since the insulation of the metal magnetic powder itself is low and a pressure applied for forming the molded body is increased to make the density of the metal magnetic material higher, as shown in FIG. 6, a winding part 61a of a coil 61 and an external terminal 63 come into contact with each other via the metal magnetic powder located between the winding part 61a of the coil 61 and the external terminal 63 in a direction P of application of the pressure for forming the molded body, resulting in a problem that a reduction in insulation more easily causes a short circuit as indicated by S.

The present disclosure facilitates addressing the above shortcoming by providing a high performance surface-mount inductor with high insulation.

A first aspect of the present disclosure provides a surface-mount inductor that includes a coil formed by winding a conductor, a molded body made of a sealing material containing a metal magnetic material and a resin with the coil enclosed therein, and an external terminal connected to the coil. The molded body has, in a surface perpendicular to a coil axis of the coil, a first region having a filling factor of the metal magnetic material lower than an average filling factor of the metal magnetic material in the whole of the molded body. The external terminal is disposed on a region at least including the first region.

A second aspect of the present disclosure provides a surface-mount inductor that includes a coil formed by winding a conductor, a molded body made of a sealing material containing a metal magnetic material and a resin with the coil enclosed therein, and an external terminal connected to the coil. The molded body has, in a surface perpendicular to a coil axis of the coil, a third region having a center particle diameter D50 of the metal magnetic material smaller than a center particle diameter D50 of the metal magnetic material in the whole of the molded body. The external terminal is disposed on a region at least including the third region.

The inductor of the present disclosure is a surface-mount inductor that includes a coil formed by winding a conductor, a molded body made of a sealing material containing a metal magnetic material and a resin with the coil enclosed therein, and an external terminal connected to the coil. The molded body has, in a surface perpendicular to a coil axis of the coil, a first region having a filling factor of the metal magnetic material lower than an average filling factor of the metal magnetic material in the whole of the molded body. The external terminal is disposed on a region at least including the first region, and therefore, the inductor can exhibit high performance while having high insulation.

The inductor of the present disclosure is a surface-mount inductor comprising a coil formed by winding a conductor, a molded body made of a sealing material containing a metal magnetic material and a resin with the coil enclosed therein, and an external terminal connected to the coil. The molded body has, in a surface perpendicular to a coil axis of the coil, a third region having a center particle diameter D50 of the metal magnetic material smaller than a center particle diameter D50 of the metal magnetic material in the whole of the molded body. The external terminal is disposed on a region at least including the third region, and therefore, the inductor can exhibit high performance while having high insulation.

A surface-mount inductor includes a coil formed by winding a conductor, a molded body with the coil sealed by a sealing material mainly containing a metal magnetic material and a resin, and an external terminal connected to the coil. The molded body has two surfaces orthogonal to a coil axis of the enclosed coil, and at least one surface side thereof is provided with a first region having a filling factor of the metal magnetic material smaller than a filling factor of the metal magnetic material in the other portion of the molded body. Therefore, the filling factor of the metal magnetic material in the first region is smaller than the filling factor of the metal magnetic material in the whole of the molded body. In the molded body, a plurality of metal magnetic materials different in center particle diameter D50 is used as the metal magnetic material, and at least one surface side of the two surfaces orthogonal to the coil axis of the enclosed coil is provided with a third region having a smaller ratio of a metal magnetic material with a large particle diameter as compared to the other portion of the molded body. Therefore, the center particle diameter D50 of the metal magnetic material contained in the third region is smaller than the center particle diameter D50 of the metal magnetic material in the whole of the molded body. The external terminal is formed on the molded body and located in a region including at least the first region or the third region and is connected to the coil.

The first region and the third region of the molded body have insulation resistance larger than the other region of the molded body. Therefore, in the molded body of the surface-mount inductor, a portion with high insulation resistance and a portion with low insulation resistance are intentionally formed. Thus, while the insulation resistance is made higher in a portion where the external terminal is formed on the surface side of the molded body, the insulation resistance can be made lower in a peripheral portion of the coil inside the molded body, i.e., the magnetic permeability can be made large, so that the performance of the inductor can be improved. The portion with high insulation resistance is the first region having a smaller filling factor of the metal magnetic material, or the third region having a smaller center particle diameter D50 of the metal magnetic material contained therein, as compared to the portion with low insulation resistance. The region having a lower filling factor of the metal magnetic material can be configured such that the center particle diameter D50 of the metal magnetic material contained therein becomes smaller, for example. The region with a smaller center particle diameter D50 of the metal magnetic material can be configured such that the content ratio of the metal magnetic material having a smaller particle diameter becomes larger than the content ratio of the metal magnetic material having a large particle diameter, for example.

The molded body may have a second region having a filling factor of the metal magnetic material higher than the first region, or a fourth region having a center particle diameter D50 larger than the third region, in the peripheral portion of the enclosed coil. By providing a region with high magnetic permeability in the peripheral portion of the coil, the surface-mount inductor can exhibit more excellent performance.

The surface of the molded body with the first region or the third region formed therein is a surface orthogonal to the coil axis of the coil enclosed in the molded body. As a result, when the surface-mount inductor is formed, for example, by pressure molding in a direction parallel to the coil axis, the deformation of the coil is suppressed, and the productivity is further improved.

The external terminal may be formed by at least partially removing the resin on the surface in the first region or the third region of the molded body, bonding the metal magnetic material exposed on the surface of the molded body to a plating layer constituting the external terminal, and connecting the external terminal and the lead-out end part of the coil. Since the resin on the surface is at least partially removed and the metal magnetic material is exposed, the formation of the plating layer more easily proceeds and the productivity is improved. Additionally, since the plating layer is improved in adhesiveness to the molded body, the strength between the molded body and the external electrode is improved.

The first region and/or the third region may be disposed at least on the substrate mounting surface side of the surface-mount inductor. By disposing the region on the substrate mounting surface side, the first region and/or the third region can more easily be formed, and the productivity is further improved.

The filling factor of the metal magnetic material in the molded body is measured as follows. Across section of the molded body is observed with a scanning electron microscope (SEM) to make a calculation based on a ratio of the occupation area of the metal magnetic material to an area of an observation region and the specific gravity of the metal magnetic material.

The center particle diameter D50 of the metal magnetic material is a particle diameter corresponding to 50% volume accumulation from the small diameter side in the particle diameter distribution. The center particle diameter D50 of the metal magnetic material in the molded body can be measured as follows. A cross section of the molded body is observed with a scanning electron microscope (SEM) to calculate respective circle equivalent diameters of observed metal magnetic materials. The acquired circle equivalent diameters are used as the particle diameters of the metal magnetic materials to create a volume-based particle diameter distribution. The particle diameter at 50% volume accumulation from the small diameter side in the particle diameter distribution is defined as the center particle diameter D50.

### Examples

Embodiments of the present disclosure will now be described with reference to the drawings. It is noted that the embodiments described below exemplify the surface-mount inductor for embodying the technical ideas of the present disclosure and that the present disclosure does not limit the surface-mount inductor to the following. The members described in claims are not limited to the members of the embodiments. Particularly, dimensions, materials, shapes, relative arrangements, etc. of constituent components described in the embodiments are not intended to limit the scope of the present disclosure only thereto unless otherwise specifically described and are merely illustrative examples. In the figures, the same portions are denoted by the same reference numerals. In consideration of facilitation of description or understanding of the main points, embodiments are separately described for convenience; however, configurations shown in different embodiments can partially be substituted or combined. In the second and subsequent embodiments, the details in common with the first example will not be described, and only different points will be described. Particularly, the same actions and effects from the same configurations will not individually be referred to in each embodiment.

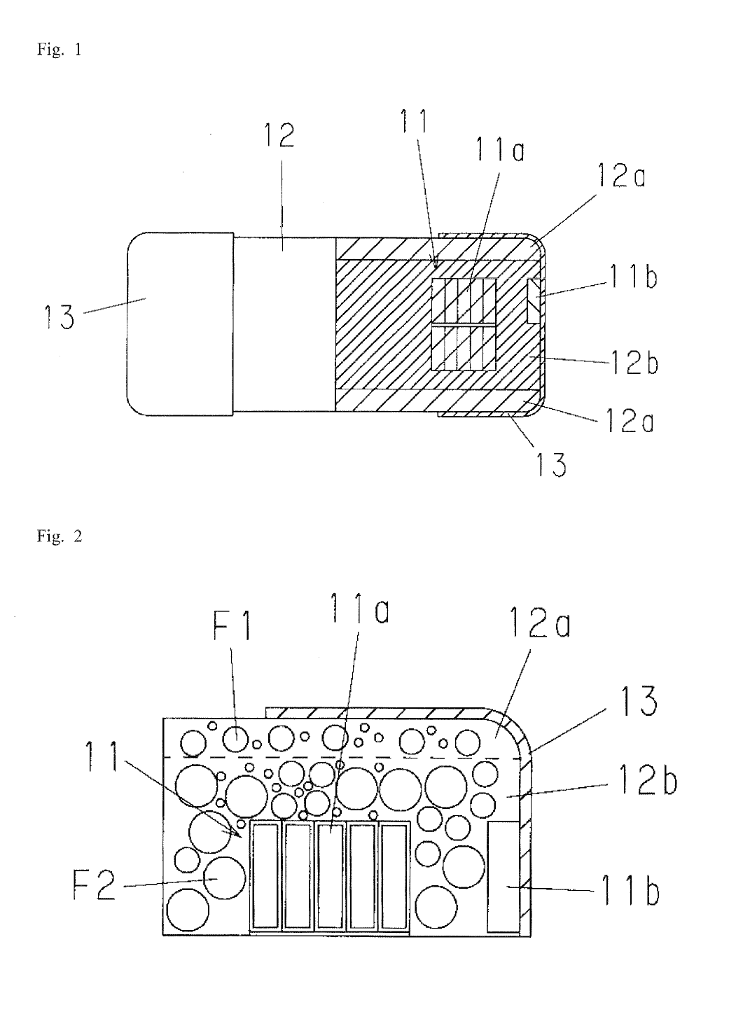

FIG. 1 is a partial cross-sectional view of a first example of the surface-mount inductor of the present disclosure. In FIG. 1, 11 denotes a coil, and 12 denotes a molded body. The coil 11 is formed to include a winding part 11a in which a conductor is spirally wound in outside-to-outside manner in two tiered such that both end portions thereof are located on the outer circumference, and lead-out end parts 11b led out from the winding part 11a in a longitudinal direction of the molded body 12. For the conductor, a rectangular wire having a rectangular cross section is used. For the lead-out end parts 11b, both end portions of the conductor are led out from the winding part 11a to face each other across the winding part 11a.

The molded body 12 is formed to enclose the coil 11 by using a sealing material containing a resin and a metal magnetic material. The molded body 12 has two surfaces (also referred to as upper and lower surfaces) orthogonal to the coil axis, longitudinal-direction side surfaces parallel to the coil axis and orthogonal to the longitudinal direction of the molded body 12, and lateral-direction side surfaces parallel to the coil axis and orthogonal to the longitudinal-direction side surfaces. For the sealing material, for example, an iron-based metal magnetic powder and an epoxy resin are used as the metal magnetic material and the resin, respectively, and a mixture thereof is used. The molded body 12 has surface sides extending perpendicular to the direction parallel to the coil axis, i.e., the direction of compression for molding (in this example, both upper and lower surfaces extend in directions perpendicular to the direction parallel to the coil axis), and each surface side is provided with a first region 12a having a filling factor of the metal magnetic material lower than an average filling factor of the metal magnetic material in the whole of the molded body 12. A peripheral portion of the coil 11 is provided with an adjacent second region 12b having a filling factor of the metal magnetic material higher than the filling factor of the metal magnetic material in the first region. Surfaces of the lead-out end parts 11b of the coil 11 are exposed on the longitudinal-direction side surfaces of the molded body 12.

External terminals 13 are each formed over one of the longitudinal-direction side surfaces of the molded body 12 and four surfaces adjacent to this side surface, and the lead-out end part 11b of the coil 11 and the external terminal 13 are connected. The external terminal 13 is formed of a conductive paste, for example.

Although the first region 12a is entirely formed on each of the two surfaces perpendicular to the coil axis, the region may partially be formed, for example, in regions of the molded body 12 adjacent to where the external terminals 13 are formed.

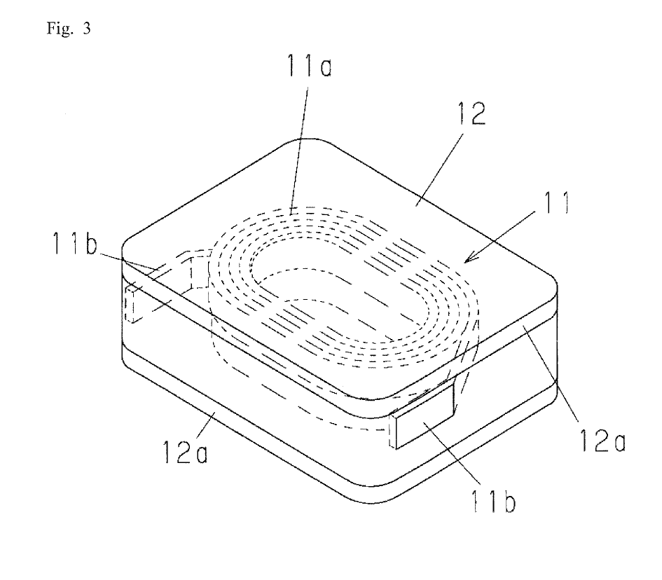

In the surface-mount inductor, as shown in FIG. 1, the first region 12a and the second region 12b are formed in the molded body 12, and the external terminal 13 is formed on the first region 12a and on the longitudinal-direction side surface of the molded body. FIG. 2 is a partially enlarged view of the cross section of FIG. 1, which is a schematic cross-sectional view of a relationship of the first region 12a, the second region 12b, and the external terminal 13. In FIG. 2, a filling factor of a metal magnetic powder F1 in the first region 12a is lower than a filling factor of a metal magnetic powder F2 in the second region 12b. The first region 12a is formed at a predetermined thickness over the entire upper and lower surfaces of the molded body 12 with the other portion of the molded body 12 defined as the second region 12b, and the coil 11 is enclosed in the second region 12b. In the embodiment shown in FIG. 1, the second region 12b is positioned between the winding part 11a of the coil 11 and the first region 12a along a direction parallel to the coil axis. Since the insulation of the upper and lower surfaces of the molded body 12 is high, the winding part 11a of the coil 11 and the external terminal 13 can be made less likely to contact each other via the metal magnetic powder located between the winding part 11a of the coil 11 and the external terminal 13 even though the pressure applied for forming the molded body 12 is increased to make the filling factor of the metal magnetic powder higher in a peripheral portion of the winding part 11a of the coil 11.

The surface-mount inductor as described above may be manufactured as follows. First, after the winding part 11a is formed by spirally winding a conductor having a rectangular cross section with insulating coating in outside-to-outside manner in two tiered such that both ends thereof are located on the outer circumference as shown in FIG. 3, both ends of the conductor are led out from the outer circumference of the winding part 11a to form the lead-out end parts 11b so that the coil 11 is formed. For the conductor used in this example, a conductor having an imide-modified polyurethane layer as an insulating film was used. The insulating film may be polyamide-based or polyester-based, and a film having a high heat resistance temperature is more preferable. Although the conductor having a rectangular cross section is used in this example, a conductor having a round cross section or a conductor having a polygonal cross section may be used. Although the coil 11 is formed into an elliptical shape when viewed in the coil axis direction in FIG. 3, the shape of the coil 11 is not limited to the elliptical shape.

By using a sealing material acquired by using, for example, an iron-based metal magnetic powder and an epoxy resin as the metal magnetic material and the resin, respectively, and granulating a mixture thereof into a powdered state, the molded body 12 with the coil 11 buried therein as shown in FIG. 3 is molded by a molding method such as a compression molding method, a sheet construction method, and a powder compacting method. In the case of the compression molding method, the molded body 12 is formed by adding, to upper and lower surfaces of a temporary molded body holding the coil 11, a temporary molded body having a filling factor lower than a filling factor of the metal magnetic powder of the temporary molded body, or by filling lower and upper portions in a mold with a material having a filling factor lower than the filling factor of the metal magnetic powder of the temporary molded body. In the case of the seat construction method, the molded body 12 is formed by adding to uppermost and lowermost layers of a metal magnetic material sheet constituting the molded body a metal magnetic material sheet having a filling factor lower than the filling factor of the metal magnetic powder of the other layer. In the case of the powder compacting method, the molded body 12 is formed by filling lower and upper portions in a mold with a material having a filling factor lower than the filling factor of the metal magnetic powder of the other portion. The lead-out end part 11b of the coil 11 is led out such that a surface thereof is exposed at a position where the external terminal is formed on the longitudinal-direction side surface of the molded body 12.

In the molded body 12 with the air core coil 11 incorporated therein in this way, as shown in FIG. 1, the surface sides orthogonal to the direction of compression for molding, i.e., the direction parallel to the coil axis, are provided with the first region 12a having a filling factor of the metal magnetic material lower than a filling factor of the metal magnetic material in the other portion of the molded body, and the peripheral portion of the coil 11 is provided with the second region 12b having a filling factor of the metal magnetic material higher than the filling factor of the metal magnetic material in the first region 12a.

Subsequently, after removing the insulating film on the surface of the lead-out end part 11b of the coil 11 by mechanical peeling, a conductive paste is applied over the longitudinal-direction side surface of the molded body 12 and the four surfaces adjacent to the side surface so as to form the external terminal 13. The external terminal 13 is connected to the lead-out end part 11b of the coil 11 exposed on the longitudinal-direction side surface of the molded body 12.

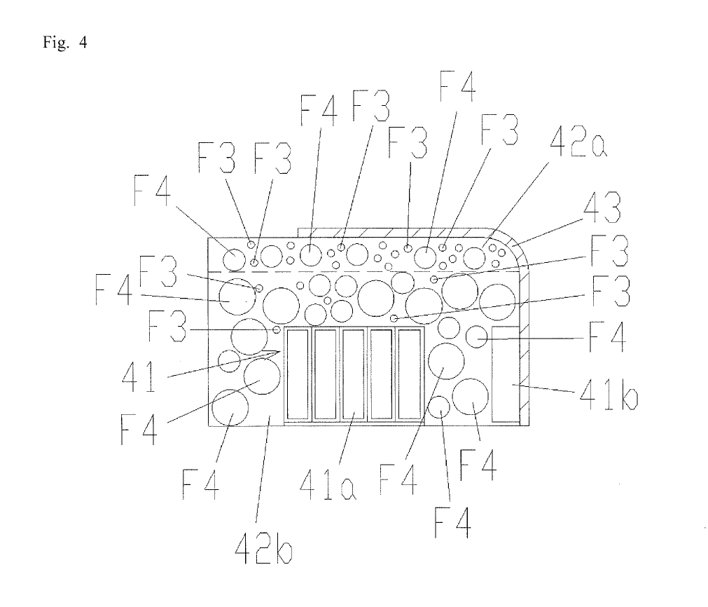

FIG. 4 is a schematic cross-sectional view of a relationship of a third region 42a, a fourth region 42b, and an external terminal 43 in a portion where the external electrode 43 of the molded body is formed in a second example of the surface-mount inductor of the present disclosure. In the second example, the third region 42a having a larger content ratio of the metal magnetic material with a small particle diameter as compared to the other portion of the molded body 42 is formed in a surface orthogonal to the coil axis of the molded body 42.

In this example, as in the first example described above, the molded body 42 encloses a coil including a winding part 41a in which a conductor is spirally wound in outside-to-outside manner in two tiered such that both end portions thereof are located on the outer circumference and a lead-out end part 41b led out from the winding part 41a. The molded body 42 is formed by using a plurality of metal magnetic materials different in center particle diameter D50 as the metal magnetic material in addition to a resin, such that the surface side orthogonal to the coil axis is provided with the third region 42a having a larger ratio of a metal magnetic material F3 with a small particle diameter (e.g., particle diameter less than 10 μm) as compared with the other portion of the molded body 42, for example, the inside of the molded body 42, while a peripheral portion of the coil is provided with an adjacent fourth region 42b having a larger ratio of a metal magnetic material F4 with a large particle diameter (e.g., particle diameter of 10 μm or larger) as compared with the third region 42a of the molded body. Therefore, the molded body 42 has the two surfaces orthogonal to the coil axis and has, in at least one of the two orthogonal surfaces, the third region 42a having the center particle diameter D50 of the metal magnetic material smaller than the center particle diameter D50 of the metal magnetic material in the whole of the molded body 42. The surface of the lead-out end part 41b of the coil is exposed on the longitudinal-direction side surface of the molded body 42.

The external terminal 43 is formed over the longitudinal-direction side surface of the molded body 42 and four surfaces adjacent to the side surface, and the lead-out end part 41b of the coil and the external terminal 43 are connected.

In the surface-mount inductor formed in this way, as in the example described above, the insulation of the entire upper and lower surfaces of the molded body 42 becomes higher, and the winding part 41a of the coil 41 and the external terminal 43 can be made less likely to contact each other via the metal magnetic powder located between the winding part 41a of the coil 41 and the external terminal 43 even though the pressure applied for forming the molded body is increased to make the density of the metal magnetic powder higher in a peripheral portion of the winding part 41a of the coil 41.

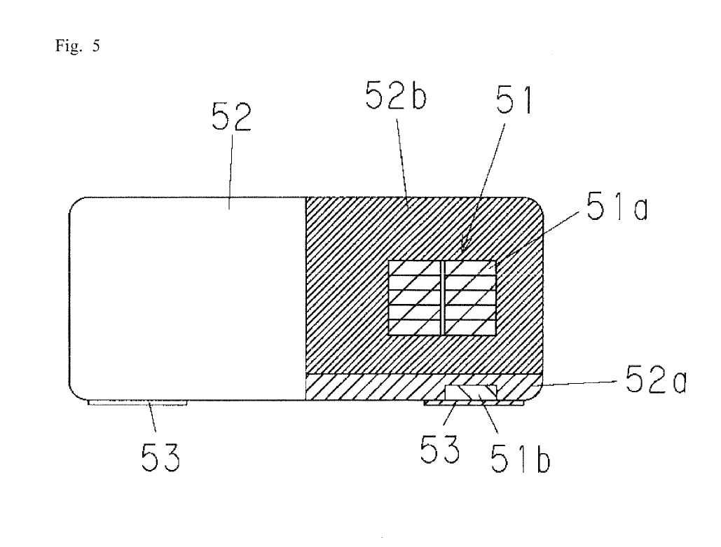

FIG. 5 is a partial cross-sectional view of a third example of the surface-mount inductor of the present disclosure. In the third example, a first region having a small filling factor of the metal magnetic material is formed on a substrate mounting surface (also referred to as a bottom surface) of the surface-mount inductor, and a lead-out end part of a coil is exposed on the substrate mounting surface.

A coil 51 is formed as a coil including a winding part 51a in which a conductor is spirally wound in outside-to-outside manner in two tiered such that both end portions thereof are located on the outer circumference and lead-out end parts 51a led out from the winding part 51a. For the conductor, a rectangular wire having a rectangular cross section is used. For the lead-out end parts 51b, both end portions of the conductor are led out from the winding part 51a and bent such that the end portions can be positioned on the bottom surface of the molded body 52.

The molded body 52 is formed to enclose the coil 51 by using a sealing material containing a resin and a metal magnetic material. For the sealing material, for example, an iron-based metal magnetic powder and an epoxy resin are used as the metal magnetic material and the resin, respectively, and a mixture thereof is used. The molded body 52 has the bottom surface side provided with a first region 52a having a filling factor of the metal magnetic material lower than a filling factor of the metal magnetic material in the other portion of the molded body, and has a peripheral portion of the coil 51 provided with a second region 52b having a filling factor of the metal magnetic material higher than the filling factor of the metal magnetic material in the first region 52a. In the embodiment shown in FIG. 5, the second region 52b is positioned between the winding part 51a of the coil 51 and the first region 52a along a direction parallel to the coil axis. Surfaces of the lead-out end parts 51b of the coil 51 are exposed on the bottom surface of the molded body 52.

External terminals 53 are formed on the first region 52a of the bottom surface of the molded body 52, and the lead-out end parts 51b of the coil 51 and the external terminals 53 are connected. The external terminals 53 are each formed of a plating layer formed by removing the resin component on the surface of the portion of the molded body 52 where the external terminal 53 is formed, so as to expose the metal magnetic powder, and applying plating with a metal material such as Ni and Sn.

Although the examples of the surface-mount inductor of the present disclosure have been described, the present disclosure is not limited to these examples. For example, the external terminals may be formed by using sputtering. Although the first region is formed on the entire surface perpendicular to the direction of compression for molding in the examples, the first region may be formed in a portion of the corresponding surface. In this case, the first region may be selectively formed in a portion of the corresponding surface where the external terminal is formed. For example, first regions may be formed only in regions adjacent to external terminals, respectively.

It is to be understood that although the present disclosure has been described with regard to preferred embodiments thereof, various other embodiments and variants may occur to those skilled in the art, which are within the scope and spirit of the disclosure, and such other embodiments and variants are intended to be covered by the following claims.

All publications, patent applications, and technical standards mentioned in this specification are herein incorporated by reference to the same extent as if each individual publication, patent application, or technical standard was specifically and individually indicated to be incorporated by reference.

What is claimed is:

1. A surface-mount inductor comprising:
a coil made of a conductor wound about a coil axis;
a molded body made of a sealing material containing a metal magnetic material and a resin with the coil enclosed therein; and
an external terminal connected to the coil, wherein
the molded body has, in a surface perpendicular to the coil axis of the coil, a first region having a filling factor of the metal magnetic material lower than an average filling factor of the metal magnetic material in the whole of the molded body, and wherein
the external terminal is disposed on a region of the molded body at least including the first region.

2. The surface-mount inductor according to claim 1, wherein adjacent to a peripheral portion of the coil in the molded body, the surface-mount inductor has a second region having a filling factor of the metal magnetic material higher than the filling factor of the metal magnetic material in the first region.

3. The surface-mount inductor according to claim 2, wherein the second region is positioned between the coil and the first region in a direction parallel to the axis of the coil.

4. The surface-mount inductor according to claim 1, wherein the first region is formed only in one or more surfaces of the molded body perpendicular to a coil axis of the coil.

5. The surface-mount inductor according to claim 1, wherein the first region is selectively provided in the region of the molded body where the external terminal is disposed.

6. A surface-mount inductor comprising:
a coil made of a conductor wound about a coil axis;
a molded body made of a sealing material containing a metal magnetic material and a resin with the coil enclosed therein; and
an external terminal connected to the coil, wherein
the molded body has, in a surface perpendicular to the coil axis of the coil, a third region having a center particle diameter D50 of the metal magnetic material smaller than a center particle diameter D50 of the metal magnetic material in the whole of the molded body, and wherein
the external terminal is disposed on a region of the molded body at least including the third region.

7. The surface-mount inductor according to claim 6, wherein in a peripheral portion of the coil in the molded body, the surface-mount inductor has a fourth region having a center particle diameter D50 of the metal magnetic material larger than the center particle diameter D50 of the metal magnetic material in the third region.

8. The surface-mount inductor according to claim 7, wherein the fourth region is positioned between the coil and the third region in a direction parallel to the axis of the coil.

9. The surface-mount inductor according to claim 6, wherein the third region is formed only in one or more surfaces of the molded body perpendicular to a coil axis of the coil.

10. The surface-mount inductor according to claim 6, wherein the first region is selectively provided in the region of the molded body where the external terminal is disposed.
